(19) United States
(12) Patent Application Publication
(10) Pub. No.: US 2021/0163126 A1
(43) Pub. Date: Jun. 3, 2021

(54) MODULAR UNMANNED AUTOMATED TANDEM ROTOR AIRCRAFT

(71) Applicant: Avidrone Aerospace Incorporated, Breslau (CA)

(72) Inventors: Scott Gray, Breslau (CA); Richard Van Wijngaarden, Breslau (CA); Todd Paleczny, Breslau (CA)

(21) Appl. No.: 17/051,895

(22) PCT Filed: Apr. 30, 2019
(86) PCT No.: PCT/CA2019/050560

§ 371 Date: Oct. 30, 2020

Related U.S. Application Data
(60) Provisional application No. 62/664,727, filed on Apr. 30, 2018.

(51) Int. Cl. B64C 27/08; B64C 1/22; B64C 39/02

(52) U.S. Cl. CPC B64C 27/08; B64C 1/22; B64C 39/024; B64C 2201/128; B64C 2201/042; B64C 2201/108; B64C 2201/024

(57) ABSTRACT

A unmanned tandem two rotor aircraft is provided. Rotor systems each containing drive motors and power sources are interconnected by a connecting body structure for supporting a payload. A payload rack may support one of more payloads that can separately be ejected as desired.

### FIELD

This disclosure relates to an unmanned automated tandem rotor aircraft, including payload controls and control for such an aircraft.

### BACKGROUND

Automated unmanned aircraft come in a variety of shapes and rotor configurations. A common arrangement for unmanned aircraft includes four or six rotors on rotor arms about a central module. Such aircraft requires particular rotor control operations to maintain flight of the aircraft. Aircraft of a quad/multi-rotor designs have relatively simply aerodynamic models and available flight control software. This design requires substantial power to operate the aircraft, limiting its capacity to carry payloads.

It is therefore desirable to have a more flexible unmanned aircraft for carrying payloads.

### SUMMARY

A tandem unmanned aircraft for transporting one or more payloads is disclosed. The aircraft includes a first rotor system, comprising a flight control system, and a motor driving plurality of rotor blades, and a second rotor system, comprising a flight control system, and a motor driving plurality of rotor blades. A connecting body structure interconnects the first rotor system and the second rotor system. The vehicle also includes a payload rack connected to the connecting body structure for supporting one or more payloads. The flight control system of the first rotor system and the flight control system of the second rotor system operate the tandem unmanned aircraft in flight.

### BRIEF DESCRIPTION OF THE DRAWINGS

In drawings which illustrate by way of example only a preferred embodiment of the disclosure,

FIG. 1 is a perspective view of an unmanned vehicle with a payload.

FIG. 2 is a perspective view of the unmanned vehicle of FIG. 1 releasing the payload.

FIG. 3 is a perspective view of the unmanned vehicle of FIG. 1 with the payload detached.

FIG. 4 is a front view of an unmanned vehicle with a payload attachment open.

FIG. 5 is a front view of the unmanned vehicle of FIG. 4 with the payload attachment closed.

FIG. 6 is a top view of an unmanned vehicle.

FIG. 7 is a side view of the unmanned vehicle of FIG. 6.

FIG. 8 is a side view of an unmanned vehicle with a payload.

FIG. 9 is a perspective view of an unmanned vehicle.

### DETAILED DESCRIPTION

This disclosure is directed to an automated unmanned aerial vehicle 100. The aerial vehicle is a powered, tandem rotor unmanned aerial system (UAS). The aerial vehicle may provide an on-demand and autonomous airborne resupply and various container and sensor air-lifting capability. The aerial vehicle may be capable of beyond visual line of sight (BVLOS) flight, including for airborne resupply missions. The range of operation may vary based on payload weight.

The aerial vehicle 100 may include a flight control system and autopilot system. The aerial vehicle 100 may communicate with and operate in conjunction with a ground control station. The ground control station may include elements of the flight control system, autopilot system and mission planning systems, such as using software running at a ground control station. The aerial vehicle 100 may be equipped with a cargo area configured to hold various payloads as desired by the user. The aerial vehicle 100 may be designed for fast, quiet, precise point-to-point BVLOS cargo deliveries within an operational envelope that varies based on payload weight.

The user, such as an operator, or ground based pilot, may define mission parameters for the aerial vehicle 100 using the ground control station or other input devices. The aerial vehicle 100 may execute the mission according to its flight plan. The light plan may landing at the destination. At the destination, the cargo may be unloaded either automatically or manually by a receiving user. Once the delivery is complete, the aerial vehicle 100 may take off and returns to its departure point or, optionally, to a different location.

The aerial vehicle 100 may be faster, have greater payload capacity, and increased flight endurance over other UAV systems. Other UAV systems are typically built around a multi-rotor architecture (more than two rotors, usually 4). This advantages may arise from the tandem rotor architecture and associated flight control system.

The aerial vehicle may use advanced composites and carbon fiber materials that reduce the vehicle's weight. The aerial vehicle may performance at four times the efficiency of multi-rotor type UAVs. Unless otherwise noted, for the purposes of this document, multi-rotor type aircraft will refer to aircraft with four or more rotors.

The aerial vehicle 100 design may have an advantage of endurance that results in long-distance flights with heavier payloads than other typical designs of UAVs. Tandem rotor systems may be superior to other rotor systems for long duration, heavy lift, and high-performance flights. Such a rotor system has been used for manned aerial vehicles, such as the CH-47 Chinook. Single rotor systems, with a tail rotor, have a disadvantage since the probability of tail-rotor damage is high due hitting obstacles.

Tandem rotor systems not only eliminate the risk of tail-rotor damage but provide an efficient use of lifting surfaces to improve the lift of the aircraft. Improved lift may improve the payload capacity. Tandem rotor systems may also more efficient in transit flight than multi-rotor UAV for airborne deliveries. The aerial vehicle 100 may use large rotors that are intrinsically more energy efficient than the smaller rotors typically found in multi-rotor UAVs. This increased efficiency results in a higher endurance for a given power source.

Typical multi-rotor (more than 2) UAVs have a payload to gross weight capacity ratio of less than 1:1. By comparison, aerial vehicle 100 may have a larger payload to gross weight ratio, such as having a ratio of more than 4:1. The size and scale variants of the aerial vehicle 100 design can be varied such as having various lengths and rotor/propeller diameters to accommodate the desired payload or cargo container. Depending on the scale, the aerial vehicle 100 may have a weight of less than 1 lbs or larger than 1000 lb gross weight or anywhere in between.

Some feature that may be included in the tandem rotor aerial vehicle include a scalable, modular, tandem rotor lifting platform. The body may be lengthwise scalable to allow for variants without redesign of the entire aircraft. The aerial vehicle may be used for or with resupply, delivery, multi-payloads, sensors, data communication radios, robotic arms, detachable devices, containers and air-lifted goods.

The aerial vehicle may allow for the re-centering of the payload while in flight, and/or on the ground to re-establish center of gravity. Maintaining a centered payload mass (weight) may be important to the flight stability and performance of the aircraft. For multiple items of cargo, or payloads, that may be ejected or dropped from the aircraft at different times during the flight or during landing followed by subsequent flight (automatically by the flight control system, or by user input remotely/wireless control), the vehicle may have the ability to mechanically move the cargo/payload mass towards the center of the vehicle. In doing so, the center of gravity of the combination of vehicle and payload may be moved. If payload is too far from the center of gravity of the vehicle, such as being too far aft or forward of the center of gravity of the vehicle, flight of the vehicle may be unstable or less efficient. The autopilot system flight control, knowing the weight of the payload by sensor or by user input to the system of the various cargo or packages, may automatically move the item(s) along the x or y (longitudinal or lateral) axes of the aircraft to keep the combination of the vehicle and payload center of gravity at a more preferred location for safe and stable flight. The payload mechanism may comprise the use of linear tracks, beams, and/or rollers to allow for the movement of the payload items about the aircraft's structure. The movement may be done electromechanically with actuators, linear drives, lead screws, or belt driven motion to relocate the payload.

The aerial vehicle may include a payload/package dropping system with user/recipient authentication methods.

The aerial vehicle may also include safety and environmental innovations, a low noise signature, high speed forward flight capabilities and aerodynamics, vertical takeoff and landing capability and modular motor/drive units.

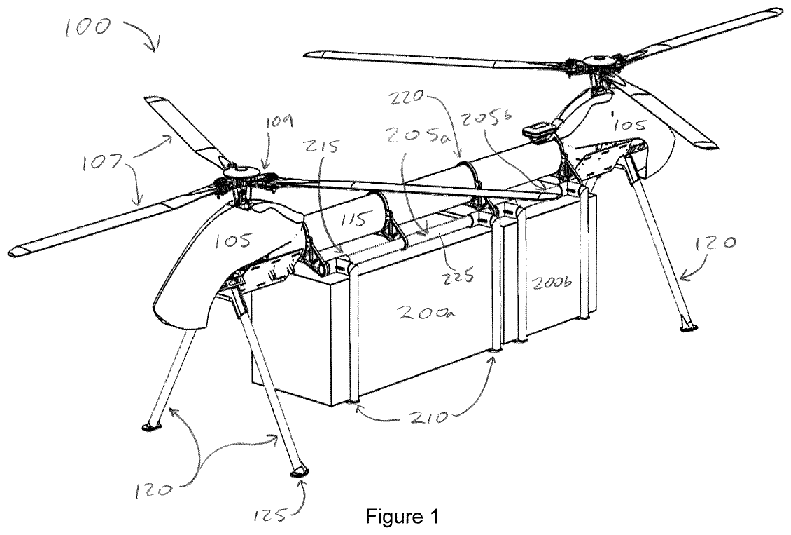

With reference to FIG. 1, the aerial vehicle 100 may comprise two rotor systems or modules 105 arranged in tandem (in-line), separated by a connecting body structure 115. The rotor systems 105 may be of a consistent or shared design between multiple instances of the rotor system 105. In this way, a defective, worn out, or damaged rotor system may be replaced with a replacement rotor unit and can be replaced at either end of the vehicle. Each rotor system 105 may include a propeller with two or more blades 107.

The connecting body structure 115 may be formed of one or more tubes. The connecting body structure 115 may provide structural form to the vehicle 100 to maintain the rotor systems in relation with each other. The connecting body structure 115 may be a tube made of carbon fiber or other material, and provide rigidity in lengthwise axis of the structure and joins the two separate rotor systems. The connecting body structure 115 may be a light-weight hollow tube. Having the connecting body structure a tube may allow for a reduction in weight and also to allow communications signals, such as electrical wires, to pass down the inside of the tube to connect the rotor modules and any payload systems. The connecting body structure may be a channel, or I-beam or other structural shape to provide rigidity and strength and without much extraneous material.

The rigidity in longitudinal axis is preferred. The arrangement of the connecting body structure 115 may allow some twisting moment in one axis only, along the centerline of the tandem arrangement of the rotor systems 105. This designed-in twisting allowance of the structure allows the front and rear rotor systems to rotate/twist such that the front and rear rotors can roll some degrees independent of each-other, thus allowing a yaw motion of the entire aircraft in flight.

Some tandem rotor helicopters have rigid bodies, and the rotor systems have complex articulating rotor heads to allow the front and rear rotor discs to have independent angles of attack. If the aerial vehicle 100 has a twisting moment in the connecting body structure 115 and rotor systems 105, these complex rotor head systems may be avoided.

The aerial vehicle 100 may have a connecting tube structure that is used for the body structure 115 connecting the two rotor systems 105 on each end. The connecting tube 115 may simplify the design, adds strength to the aircraft without adding unnecessary weight and complication that may be arise with a built-up fuselages or frames of traditional aircraft style design.

The connecting body structure 115 may be one, or multiple tubes arranged in an array, to conjoin the two rotor systems 105, while allowing some twist, and being substantially rigid in all other axes.

Either the connecting body structure 115 or the rotor systems 105 may include landing gear 120, which preferably comprise light weight feet 125. The feet may be arranged in pairs at either end of the aerial vehicle 100. The landing gear 120 may be retractable for improved aerodynamics or fixed. In addition to, or as an alternative to, feet 125, the landing gear 120 may comprise wheels or skids.

In an embodiment, an aerial vehicle may include rotor systems 105 connected by structural tube/tube sets that may be adjoined in multiples, creating 3, 4 or more rotor configurations. Adding rotor systems 105, may multiplying the payload capacity of weight lifting of the aerial vehicle. In some configurations, such as having an odd-number of main rotors, torque balancing rotors may be included.

Each rotor system 105 may include a motor drivetrain, and may be driven by an motor. The drive may be directly driven by the motor or through a gear reduction drive train arrangement to suit the motor. The motor is preferably an electric motor. The rotor system may employ a one-way freewheeling by a freewheel clutch in one direction to assist with autorotation descent. The aerial vehicle 100 configuration with two rotor systems requires that the rotor of the first rotor system 105 spin in the opposite direction to the rotor of the second rotor system 105 to cancel out the torques. The rotor systems 105 may be modular so that they may be placed on an connecting body structure 105 of a variety of lengths. This allows the aerial vehicle 100 to be scaled up or down to application specific needs without the need for a new fuselage/body design or new rotor systems 105 but only of a different length connecting body structure 105, such as a tube.

The rotor systems 105 may each have their own motor, motor controller, and power source such as battery, fuel cells, petrol, gas turbine, piston engine, and flight control actuators controlling the rotor blades. Each rotor system may include some or all of the flight controller or flight control system, communication systems, autopilot or other control systems for the rotor system and aerial vehicle. The control system may comprise one or more microprocessors running software. The software may maintain flight by operating the rotor systems, control the payload system, direct the aerial vehicle to its destination, avoid obstacles and perform other functions of the aerial vehicle. By having each rotor system 105 being modular and comprising the supporting equipment allows them to be easily replaced and installed by a user or operator, or at a factor and on-site during operations. The control system in each rotor system 105 may communication, such as with a wired or wireless, connection to the other rotor system 105 of the vehicle, the rotor systems are coordinated to provide for stable and directed flight. The control systems may be fully or partially redundant such that if one control system fails, the control system of the other rotor system may still operate the aerial vehicle. The communication systems may include radios to allow for two-directional communication with other aerial vehicles, ground stations and/or controllers. In an embodiment, a central control system may operate both rotor systems. A central control system may be placed in one of the rotor systems or in the body structure 115.

The rotor system 105 may include a cyclic control system or swashplate similar to that of a single rotor. The cyclic control may be used to maneuver the aerial vehicle using the front and rear rotors, such as by applying pitch and/or roll at each rotor. The rotor system may include collective pitch to proportionally control thrust of the rotor system.

Different rotor systems 105 may include a variety of different motor, rotor length and gear ratios, allowing the performance to be custom tailored to efficiency, heavy lifting, or high speed applications. The control system of the rotor system 105 may include a swashplate 109 and linkage design similar to that of manned one rotor helicopters, where roll, pitch and collective pitch of the rotor blades/propellers can be articulated by actuators. The actuators on the rotor system 105 may be controlled by a flight control system or other controller, an electronic hardware/computer to control the actuators, and automated flight control of the aircraft.

By having full cyclic and collective pitch control as part of each rotor system 105, the flight control system can therefore roll, pitch, yaw and change altitude of the aircraft in all axes and attitudes of flight.

Yaw of the aircraft as a whole may be achieved by a roll command sent to the first rotor system 105 opposite to the roll command sent to the second rotor system 105. Due to the connecting body structure 115 and the rotor systems allowing twist in one axis only, the rotor system 105 is allowed to rotate some angle off axis and therefore the lift vector of each rotor disc of the rotor system 105 can be directed to allow the aircraft to yaw and perform motions in all axes.

With reference to FIG. 9, the designed-in twisting motion is allowed by the interconnecting tube(s) structure and the mounts in the rotor systems 105. The connecting body structure 115 allows a twist motion about the lengthwise axis, thus allowing the rotor of each rotor system to change its resultant lift vector. This twist may be provided by inherent flexibility of the connecting body structure 115 or by the mounts connecting one or both ends of the connecting body structure 115 with the rotor systems 105. The differential lift vector allows yaw motion to be achieved by the entire aircraft design. Each rotor system 105 mounted to a twistable member can be vector controlled by the cyclic pitch roll command supplied by the flight control system.

Each rotor system 105 control system may be connected to the control system of the other rotor system on a tandem system or to multiple rotor systems 105. This connection allows the control systems for each rotor system 105 to coordinate and work together for stable flight. The control systems may be configured or automatically adapt to the rotor systems 105 configurations, such as obtaining information about the number of rotor systems and their capabilities. The control system therefore may determine the presence of, and specifications of each rotor system 105 used on the tandem aerial vehicle 105 or multiple rotor system platform/aircraft.

Each rotor system 105 may monitor the health condition of its components by the control system. Rotor and propeller revolutions, such as in RPMs, temperatures of motor and engine drives, battery condition, power usage, and emergency conditions may be monitored by the flight control system.

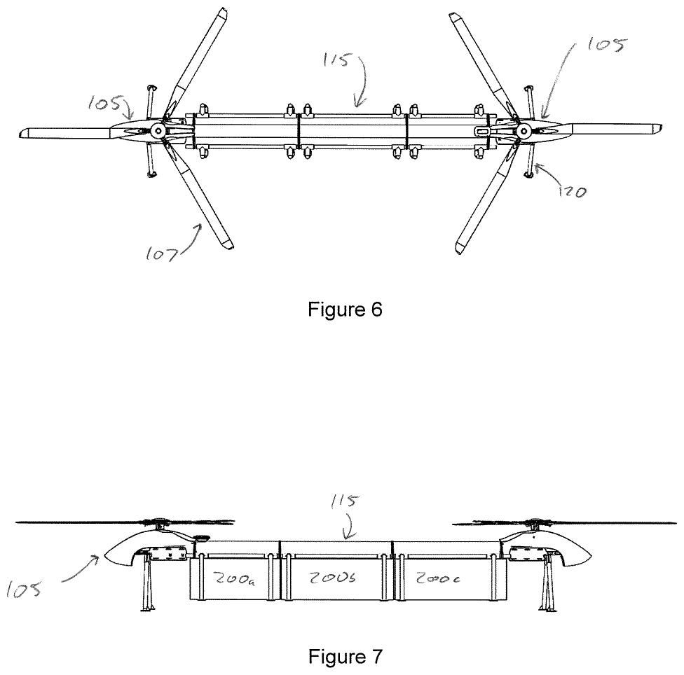

An output drive shaft or synchronization drive from a rotor system 105 may be provided to allow a timing belt or torque tube drive to interconnect the front and rear rotor systems 105. If the rotor systems 105 are close in distance from each other, such as by having a short connecting body 115, the rotor blades may intermesh. The rotors are spinning in an opposite direction to each other, and therefore they can intermesh without collision if coordinated, however the synchronization drive may be used to keep them from colliding. The rotor systems 105 may have this synchronization drive built in to regardless of the length of the connecting body 115 so that the rotor module 105 may be more easily used for a variant of the aerial vehicles with a shorter connecting body. With reference to FIGS. 6 and 7, if the interconnecting body 115 is long enough the blades will not intermesh and so no timing belt or torque tube drive may be needed even if a synchronization drive is present in the rotor systems. The timing belt or torque tube drive may pass down the centre of the connecting body. If the blades do not intermesh, no synchronization drive may be used. The control systems and/or motor controller of the rotor systems 105 may maintain and synchronize the speed of rotation of the rotors of each rotor system electronically, such as with an electronic or mechanical governor.

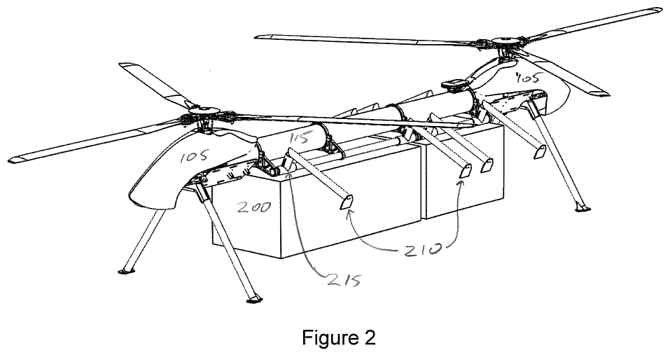

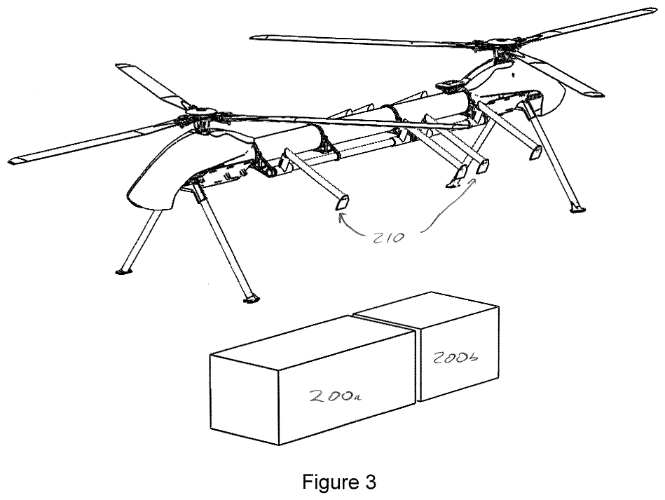

With reference to FIGS. 1, 2 and 3, in a tandem rotor configuration, the aerial vehicle 100 may have a portion of the body along the connecting body 115 between the rotor systems 105 providing the lift available for a payload 200. This area on the aerial vehicle 100 may be dedicated to payload lifting capability along the connecting body 115 such as the structural member and adjoining tube(s). The aerial vehicle 100 may use a payload rack 205. This rack 205 may be configurable in length along the connecting body 115. The rack 205 may have a telescoping width, and depth adjustments to accommodate different size payloads, such as boxes, packages, sensors, and other items that require to be affixed to or carried by the airframe.

A similar payload rack may also be employed on embodiments of multiple rotor designs having greater than two rotors.

The payload rack include articulating arms 210 which capture boxes, payloads, cargo, and/or containers of various sizes. The arms may be controlled by one or more actuators 215, such as servo motors.

The payload actuators 215 may be controlled by the control system, or flight control system/autopilot for the aerial vehicle 100 and/or indirectly by a communication from a ground station or controller operated by a human. The aerial vehicle 100 autopilot system may have the ability to release the payload at predetermined drop off locations, such as while the vehicle is on the ground at a destination or, air drop the payload while in flight. The actuators may operate the articulating arms to pick up a payload, such as at a destination, in order to transport the payload to a another location.

The payload rack 205 may include multiple sections 205a, 205b so that multiple payloads, such as packages 200a, 200b, may be carried at the same time and so that each payload may be released or picked up separately.

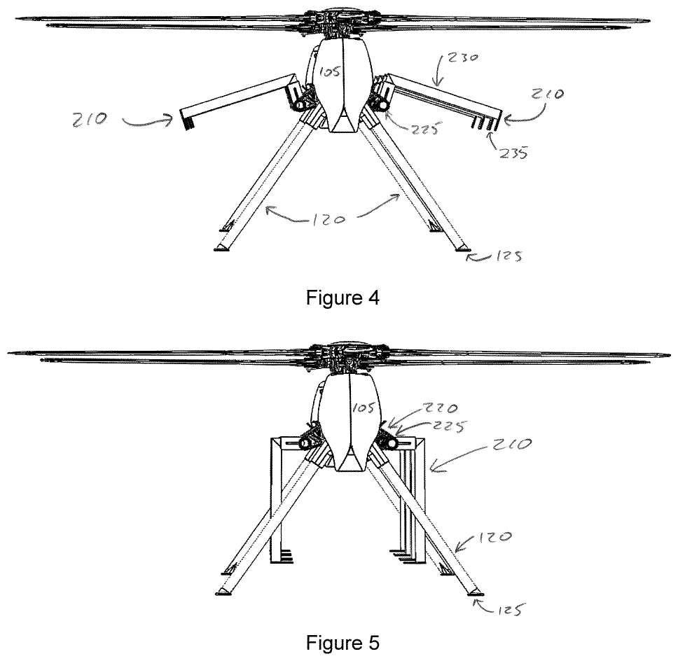

With reference to FIGS. 4 and 5, the payload rack 205 may comprise one or more mounting brackets 220. The mounting brackets 220 may attach to the connecting body structure 115, such as by having an opening through which the connecting body structure 115 passes. The mounting brackets 220 may attach to the connecting body structure 115 such as using one or more fasteners, welds or clips.

The payload rack 205 may comprise one or more payload bars 225 supported by the mounting brackets 220. The payload bars 225 may be substantially parallel to the connecting body structure 115 and two of the payload bars 225 may be away from the centre line of the aerial vehicle on opposite sides of the connecting body structure. The distance between two payload bars may be dictated by the size of the aerial vehicle and the dimensions of the payload it may carry. One or more actuators 215 may be exist within or attached to the payload bars 225. The actuators may have control and power connections to the aerial vehicle control system such as electronic wires passing through to the connecting body structure and on to one or both of the rotor systems 105. Instead of or in addition to the actuator arms, the actuators release one or more connections to the payload, such as with particular connection receptacles, fasteners, straps, or netting on the payload.

The one or more actuators may attach to the articulated arms 210. The articulated arms may support and hold a payload in position such as being generally L-shaped with a first segment 230 that connects to a substantially perpendicular holding segment 235 that passes at least partially under the payload. While shown in FIGS. 1 to 5 as being of fixed length and orientation, the articulated arms 210 may be extendable to encompass payloads of different sizes or to pick up a payload. When supporting a payload, such as in flight, the articulated arms may be biased against the payload to hold the payload in position.

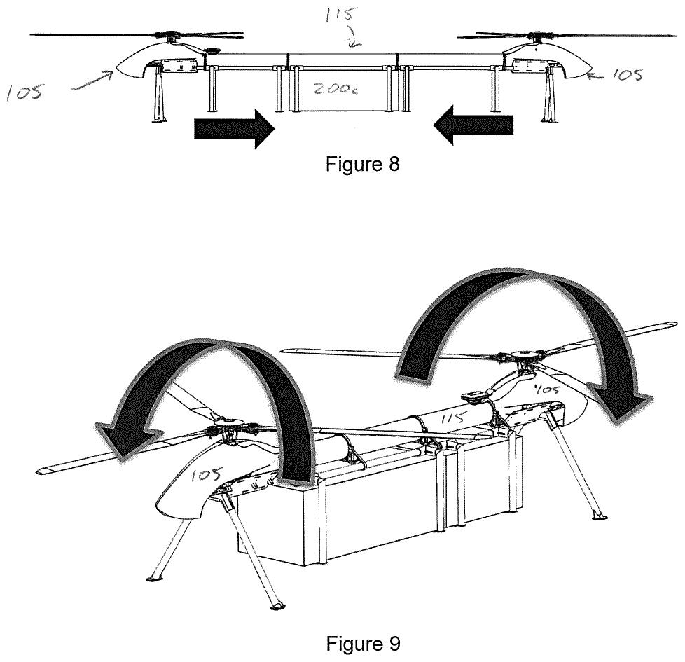

With reference to FIG. 8, to counteract the negative flight effects of off-centre payloads which may upset the aircraft's center of gravity (CG), the payload rack may move the payload so that the center of gravity is closer to the center of the aircraft by actuators which move the payload to the center of the aircraft. For example, if the aerial vehicle was carrying three payloads 200a, 200b, 200c, such as shown in FIG. 7, and two of those payloads have been ejected, such as shown in FIG. 8. The remaining payload, 200c, may be moved towards the centre of the aerial vehicle. In this way, the aerial vehicle is more evenly balanced between the two rotor systems 105.

The centre of gravity actuators may move the payload while on the ground or in flight for centre of gravity adjustment to allow improved flight and control of the aircraft. The centre of gravity actuators may be rollers, wheels or conveyors on the rack, articulated arms and/or the holding segments. This may be done if there are multiple payloads of various weights or if payloads have been ejected during the mission. The payload, such as a cargo container, may be relocated to center of the aircraft by automation and instruction by the autopilot/flight control. The automated movement of cargo may assist with re-establishes a center of gravity to allow safe flight or to improve efficiency of the aerial vehicle. Automation adjustment of the center of gravity can be done along multiple axes, restoring lengthwise and lateral center of gravity as required and depending on the features of the center of gravity actuators and payload actuators 210.

If the flight control system knows the weight of payloads, the centre of gravity actuators may automatically re-establish a more neutral CG such as by moving the payload using the centre of gravity actuators, or by picking up the payload at a preferred location on the payload rack.

The payload rack may have the ability to move its payloads by way of actuators to re-center the center of gravity of the aerial vehicle. The weight of the payloads that are released or dropped may be known to the autopilot/flight control system or determined based on the flight characteristics or weight sensors on the aircraft or payload rack, and the system may re-center the center of gravity while in flight to establish safe/efficient flight characteristics and avoid an unbalanced center of gravity of the aircraft. The re-centering of the center of gravity may be done while in flight to reduce the time on the ground and improve delivery time.

The payload of the aerial vehicle may be ejected. This may be done based on commands from a ground control station, or central control station. The payload may be ejected when the aerial vehicle has obtained a pre-determined location such as an X,Y,Z co-ordinate or longitude/latitude.

The aerial vehicle may eject the payload when a person at the landing site of the aerial vehicle pushes a button on the aerial vehicle. The aerial vehicle may then leaves the location after dropping the payload. After ejecting the payload, the aerial vehicle may then fly to its home base or to another location.

A person at the landing site may connect with the drone wirelessly, such as using software on a computer, tablet, or smartphone and initiate the aerial vehicle to eject the payload at a desired location and/or time of day, or of the flight. The request from the person at the landing site may go directly to the aerial vehicle such as over a wi-fi network created by the aerial vehicle or indirectly via one or more other computers and networks, such as to a base station.

A recipient of a payload may be identified securely such as by two-factor and/or multi-factor authentication prior to ejecting the payload. The system, such as a control system on the aerial vehicle or at a base station may confirm the recipient/user's claimed identity before the payload is dispensed/ejected.

The aerial vehicle may include one or more of several features that assist with its interactions with is surroundings. The rotor systems of the aerial vehicle may include a rotor/propeller braking system where the rotors are slowed automatically after landing. Sensors on the aerial vehicle may verify that people are away from the aerial vehicle.

An audible sound may be generated from the aerial vehicle such as from a speaker system on-board the aerial vehicle that may warn people of its arrival and landing. The audible sound may be an alarm or a verbal announcement. A warning or announcement may be made from equipment on the ground, such as at a landing zone, that is in communication with the aerial vehicle.

The aerial vehicle may include a projection light or lamp that projects on to the vehicle's intended landing zone to alert persons nearby of the location of the landing.

The rotor systems 105 may allow for a lower noise signature than other VTOL aircraft, such as by having larger but slower rotating rotors.

The autopilot in the aerial vehicle may be configured to fly the vehicle in a directly, as the crow flies, from its location to its destination. The autopilot in the aerial vehicle may be configured to fly over roadways, other existing transportation routes or other configured routes rather than direct A to B flight paths. The aerial vehicle and/or ground station may select a landing zone and/or flight path based on weather data, obstacle avoidance data and other parameters. Information used to select a landing zone and/or flight path may include external or onboard sensors. Onboard sensors may include airspeed detector, turbulence, proximity detectors.

The aerial vehicle may utilize pre-determined landing zones, such as those that are away from obstructions or people. These landing zones may be identified with coordinates such as longitude, latitude, that may be programmed into the aerial vehicle along the flight path.

In the event of power or system failure of the rotor system 105, the aerial vehicle may auto-rotate to the ground automatically such that the force of the impact with the ground is reduced, reducing damage to the aerial vehicle and any payload. Auto-rotation may use the cyclic and collective pitch control of the rotor systems. Fixed pitch propellers used on existing aerial vehicles cannot control the descent rate in a motor off condition.

The aerial vehicle may use obstacle avoidance. This may be done using various sensors to sense and avoid infrastructure, natural formations, persons and property.

The aerial vehicle and its rotor systems may include lights, such as LEDs on the rotor tips to illuminate the rotors when in flight and on the ground during take off and landing sequences, particular if the aerial vehicle is being flown at night.

Various embodiments of the present disclosure having been thus described in detail by way of example, it will be apparent to those skilled in the art that variations and modifications may be made without departing from the disclosure. The disclosure includes all such variations and modifications as fall within the scope of the appended claims.

1. A tandem unmanned aircraft for transporting one or more payloads comprising:
a first rotor system, comprising a flight control system, and a motor driving plurality of rotor blades;
a second rotor system, comprising a flight control system, and a motor driving plurality of rotor blades;
a connecting body structure interconnecting the first rotor system and the second rotor system;
a payload rack connected to the connecting body structure for supporting one or more payloads
wherein the flight control system of the first rotor system and the flight control system of the second rotor system operate the tandem unmanned aircraft in flight.

2. The tandem unmanned aircraft of claim 1 wherein the connecting body structure may twist flexibly permitting controlled yaw between the first rotor system and second rotor system.

3. The tandem unmanned aircraft of claim 1, wherein the payload rack comprises one or more payload articulating arms for supporting the one or more payloads, wherein the articulating arms have a first position supporting the one or more payloads and a second position ejecting the one or more payloads.

4. The tandem unmanned aircraft of claim 1, wherein the payload rack further comprising a center of gravity articulator that moves the one or more payloads closer to the aircraft center of gravity.

5. The tandem unmanned aircraft of claim 3, wherein the one or more payload articulating arms comprises at least a first articulated arm for supporting a first payload and a second articulated arm for supporting a second payload, wherein the first articulated arm may be moved to the second position independently of the second articulated arm.

6. The tandem unmanned aircraft of claim 3 wherein the one or more articulated arms are moved to the second position, in response to operation by a user on the group at a landing zone for the aircraft.

7. The tandem unmanned aircraft of claim 1 wherein the payload rack may release a payload in response to a command from a user interface.

8. The tandem unmanned aircraft of claim 7 wherein the user interface is on the tandem unmanned aircraft.

9. The tandem unmanned aircraft of claim 7 wherein the user interface is on a handheld device in proximity to a landing zone.

10. The tandem unmanned aircraft of claim 1 further comprising a wired communication network between the flight control system of the first rotor system and the flight control system of the second rotor system.

11. The tandem unmanned aircraft of claim 10 wherein the flight control system of the first rotor system and the flight control system of the second rotor system synchronize the rotation speeds of the plurality of blades of the first rotor system and second rotor system.

12. The tandem unmanned aircraft of claim 10 wherein the flight control system of the first rotor system controls the second rotor system and the first rotor system in the event of a failure of the flight control system of the flight control system of the second rotor system.
